(19) United States
(12) Patent Application Publication
(10) Pub. No.: US 2003/0065722 A1
(43) Pub. Date: Apr. 3, 2003

(54) Method and system for creating and managing secure shared workspaces

(76) Inventor: Taco Van Ieperen, Calgary (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/966,733

(22) Filed: Oct. 1, 2001

(51) Int. Cl. G06F 15/16

(52) U.S. Cl. 709/205

(57) ABSTRACT

A system and method for creating and managing a shared workspace in a network environment includes creating a shared workspace accessible to participants of scheduled meeting and categorize data stored in the shared workspace. The categorized data stored in the shared workspace is exposed to each participant of the scheduled meeting accessing the shared workspace through a graphical user interface. The graphical user interface enables each participant to input data into appropriate categories of the shared workspace and edit categorized data exposed through the graphical user interface. Access to the shared workspace is restricted to participants of the associated scheduled meeting based on network login information.

### SUMMARY OF THE INVENTION

The present invention relates generally to meeting productivity and in particular to a method and system for creating and managing secure shared workspaces for participants of scheduled meetings in a network environment.

### BACKGROUND OF THE INVENTION

Email and scheduling client applications for desktop, laptop and other computers are well known and are widely used by people who need to manage their time and coordinate groups. An example of such a client application is Microsoft Outlook®. In a network environment, the client email and scheduling applications run on individual workstations while a corresponding server (Exchange) application runs on a server. The client email and scheduling applications communicate with the server application and include a meeting scheduling function that enables a user to check the calendars of other users and invite available users to participate in a scheduled meeting.

In some environments, delegate accounts that represent non-human resources, such as for example meeting rooms and computer programs are created. Delegate accounts representing non-human resources that are required for a meeting are invited to the meeting in the same manner as human participants so that the non-human resources are reserved for the meeting.

Applications for monitoring delegate accounts and for creating shared workspaces for meetings to which delegate accounts are invited are also known. In these applications, when a meeting is scheduled to which a delegate account has been invited and the shared workspace has been created, randomly generated passwords are emailed to the users invited to participate in the meeting. The passwords are required in order for the participants to gain access to the shared workspace created for the meeting. Unfortunately, these applications create random passwords for each shared workspace. As a result, if a user is invited to a large number of meetings, the user is required to keep track of a large number of different passwords in order to gain access to the shared workspaces created for the meetings. This of course creates difficulties for users invited to large numbers of meetings.

In addition, prior art applications for creating shared workspaces have been limited in terms of the type and management of data stored in the shared workspaces and in terms of user access to the shared workspaces. As will be appreciated, improvements to applications of this nature are desired.

It is therefore an object of the present invention to provide a novel method and system for creating and managing a secure shared workspace associated with a scheduled meeting in a network environment.

### SUMMARY OF THE INVENTION

According to one aspect of the present invention there is provided a method for creating and managing a shared workspace in a network environment comprising the steps of:

creating a shared workspace accessible to participants of a scheduled meeting;

categorizing data stored in said shared workspace; and

exposing said categorized data stored in said shared workspace to each participant of said scheduled meeting accessing said shared workspace through a graphical user interface, said graphical user interface enabling each participant to input data into appropriate categories of said shared workspace and edit categorized data exposed through said graphical user interface.

Preferably, the data stored in the shared workspace is categorized into two or more of agenda, goals, decisions, tasks, file attachments, whiteboard notes and drawings categories. It is also preferred that the categorized data stored in the shared workspace can be exposed to multiple participants simultaneously and can be edited by multiple participants simultaneously. Changes to categorized data stored in the shared workspace made by participants are applied to the categorized data using an optimistic editing model.

The shared workspace may be created automatically when a new meeting is scheduled or may be created for a new meeting in response to user input. When a shared workspace is created for a new meeting, a link to the created shared workspace is sent to each participant of the scheduled meeting.

Preferably, access to the categorized data stored in the shared workspace is restricted to participants of the scheduled meeting based on network login information. This network login information includes user login identifications. During creation of the shared workspace the user login identifications of participants of the scheduled meeting are stored with the shared workspace. The login identification of the user accessing the shared workspace is compared with the login identifications stored with the shared workspace to determine if the user is granted access.

According to another aspect of the present invention there is provided a method for creating a secure shared meeting workspace associated with a scheduled meeting in a network environment, said method comprising the steps of:

determining the participants in the scheduled meeting;

creating a workspace for the scheduled meeting; and

restricting access to the workspace to those participants in the scheduled meeting, access being restricted based on network login information associated with said participants.

According to yet another aspect of the present invention there is provided a method of restricting access to a secure shared meeting workspace associated with a scheduled meeting entered into a schedule application in a network environment to participants of the scheduled meeting, said method comprising the steps of:

during a request for access to said workspace, comparing network login information associated with the user making said request, with network login information associated with the participants in the scheduled meeting; and

permitting access to said workspace when the user network login information corresponds with the participant login information.

According to yet another aspect of the present invention there is provided a system for creating and managing a secure shared workspace for a scheduled meeting comprising:

a workspace server executing a server shared workspace application for creating and managing a shared workspace associated with a scheduled meeting, data stored in said shared workspace being categorized and being accessible only to participants of said scheduled meeting;

an email server executing a server email and scheduling application; and

a plurality of workstations, each of said workstations executing a client email and scheduling application and a client shared workspace application, said client shared workspace application including a graphical user interface to enable each participant of said scheduled meeting to access and edit categorized data stored in said shared workspace.

The present invention provides advantages in that participants of a scheduled meeting are able to access and edit data stored in the shared workspace associated with the scheduled meeting in an easy manner. This is due to the fact that the data stored in the shared workspace is organized into categories. The categorized data is exposed to each participant accessing the shared workspace via a client shared workspace application that includes an intuitive graphical user interface. Also, the present invention provides advantages in that multiple participants of a scheduled meeting can edit data stored in the shared workspace associated with the scheduled meeting simultaneously and be made aware of changes to the data in the shared workspace made by other participants.

The present invention provides further advantages in that since the network user names and passwords of the participants invited to a scheduled meeting are used to enable invited participants to access the shared workspace created for the meeting, participants who are logged into the network are not required to provide a password or login ID to access the shared workspace. Also, since network IDs and passwords are used, the requirement for users to remember a large variety of passwords is avoided. It also increases security since there is only one point of failure on the network.

The present invention provides yet further advantages in that users participating in a scheduled meeting can be distinguished allowing different rights to be assigned to users accessing the shared workspace created for the meeting. Also, shared workspaces can be designated as private to inhibit sensitive information associated with private meetings from being accessed by individuals who are performing searches but who are not participants of the private meetings.

### BRIEF DESCRIPTION OF THE DRAWINGS

An embodiment of the present invention will now be described more fully with reference to the accompany drawings in which:

FIG. 1 is a schematic diagram of a computer network running an email and scheduling application and a shared workspace application for creating and managing shared workspaces associated with scheduled meetings;

FIGS. 2a and 2b are flowcharts showing the steps performed when a new meeting is scheduled;

FIG. 3 is a scheduled meeting form including an attached shortcut to a shared workspace;

FIG. 4 is a flowchart showing the steps performed during creation of a shared workspace for a scheduled meeting;

FIGS. 5a and 5b are flowcharts showing the steps performed when a user accesses a shared workspace;

FIG. 6a shows a login form presented to a user who has been denied access to a shared workspace;

FIG. 6b shows a prompt presented to a user who has failed logging into a shared workspace;

FIGS. 7a and 7b show agenda and whiteboard pages of a client shared workspace application graphical user interface; and

FIG. 8 shows a form presenting the results of a shared workspace search.

### DETAILED DESCRIPTION OF THE PREFERRED EMBODIMENT

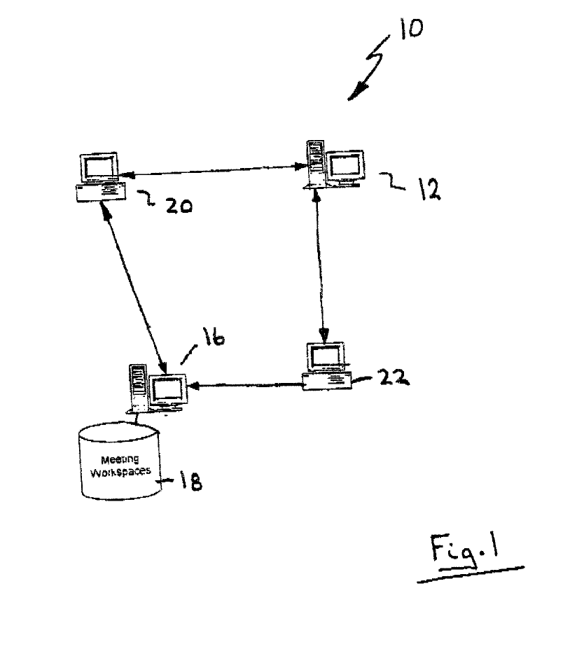

Turning now to FIG. 1, a computer network is shown and is generally identified by reference numeral 10. As can be seen, the computer network 10 includes an email server 12, a shared workplace (SW) server 16 that creates and manages secure shared workspaces 18 for scheduled meetings, and a plurality of workstations 20 and 22, only two of which are shown for ease of illustration.

The email server 12 runs a server email and scheduling application. In the present embodiment, the server email and scheduling application is Microsoft Exchange. Each of the workstations 20 and 22 runs a corresponding client email and scheduling application, in this particular example Microsoft Outlook®. In this manner, the email and scheduling application running on the email server 12 is accessible to users. A user opening a client email and scheduling application running on a workstation can schedule a new meeting and invite other users to participate in the meeting or can alter existing scheduled meetings created by that user.

The SW server 16 runs a server shared workspace application that enables shared workspaces 18 for meetings to be created and updated. The shared workspaces 18 created for meetings can be used to store information relevant to the meetings and/or to the users invited to the meetings. This information may include for example agendas, goals, decisions, tasks, notes, file attachments, electronic whiteboard notes and/or drawings. Each shared workspace 18 is however secure, in that only users who are invited to the meeting associated with the shared workspace are able to access the shared workspace. Thus, users can store sensitive information in the shared workspaces without worrying that the sensitive information will be accessed by users who are not participating in the meetings.

Each of the workstations 20 and 22 also runs a client shared workspace application that interacts with the client email and scheduling application. In this manner, when a user schedules a new meeting, a shared workspace 18 associated with the new meeting can be set up on the SW server 16. Also, when a user alters a scheduled meeting for which a shared workspace 18 has previously been created, the shared workspace on the SW server 16 can be updated.

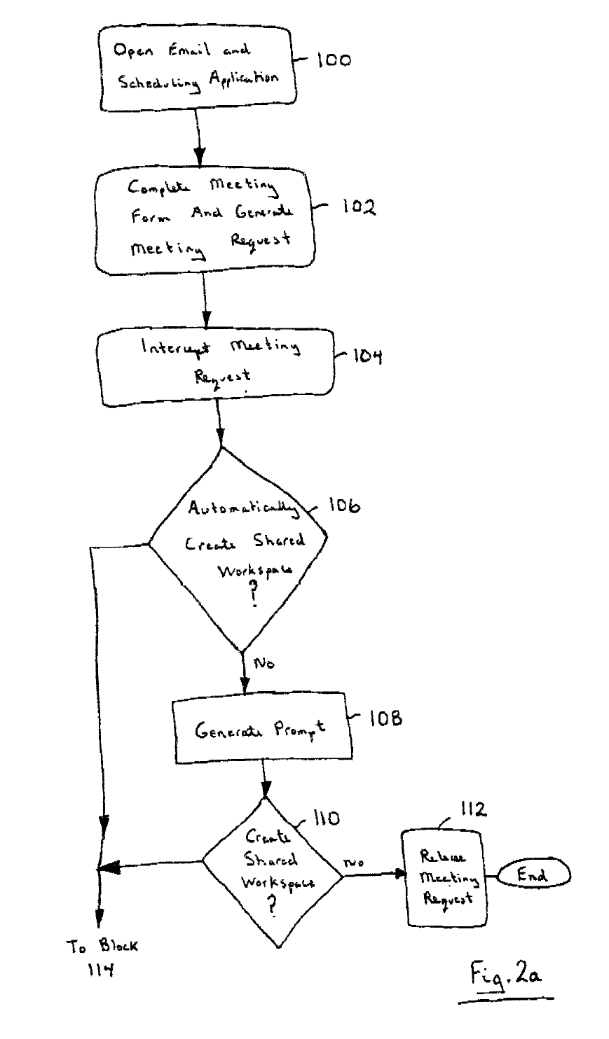

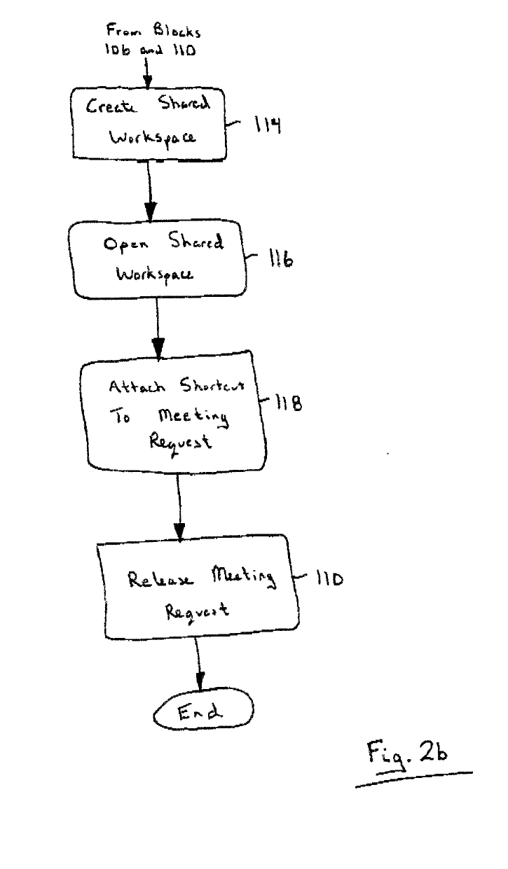

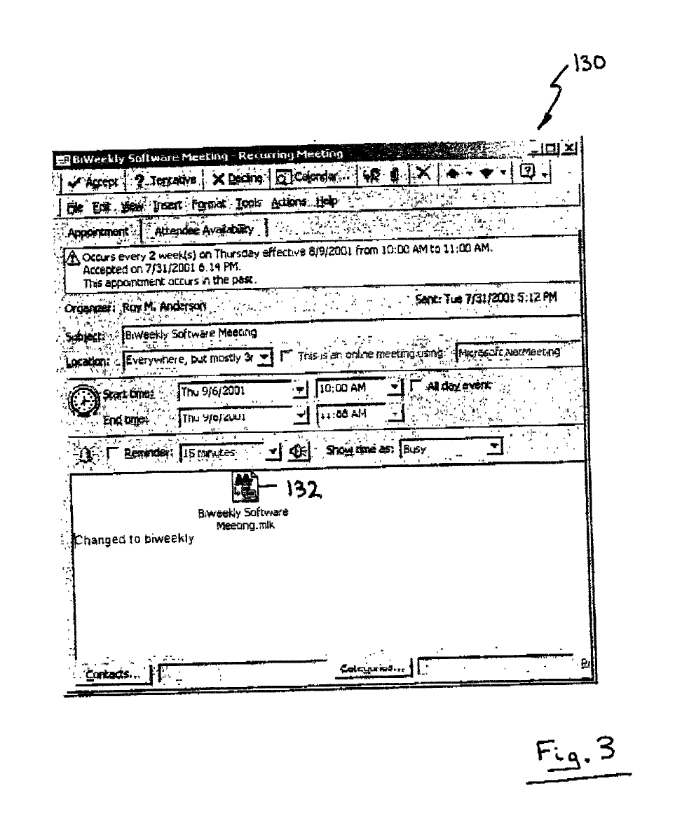

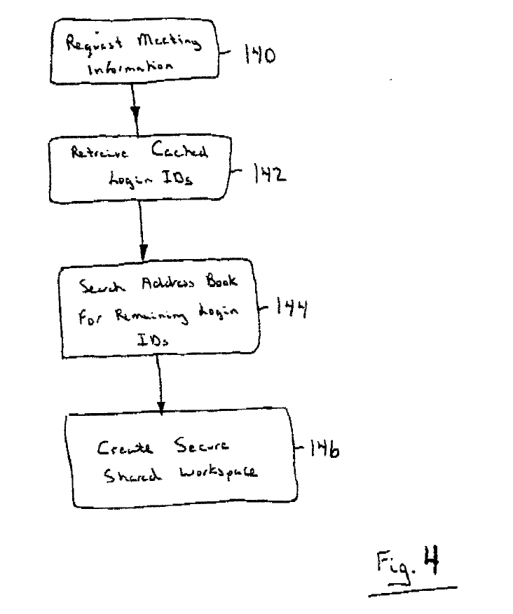

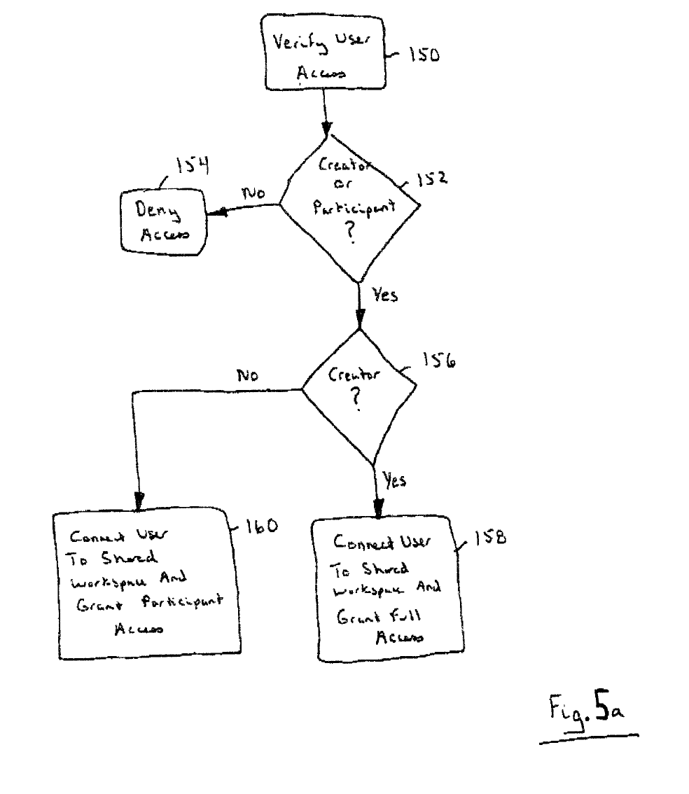

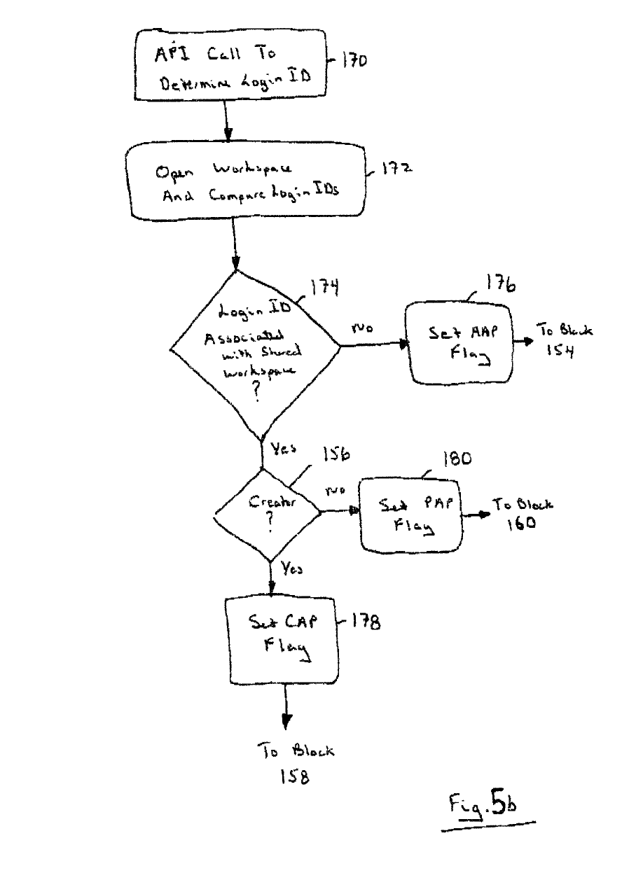

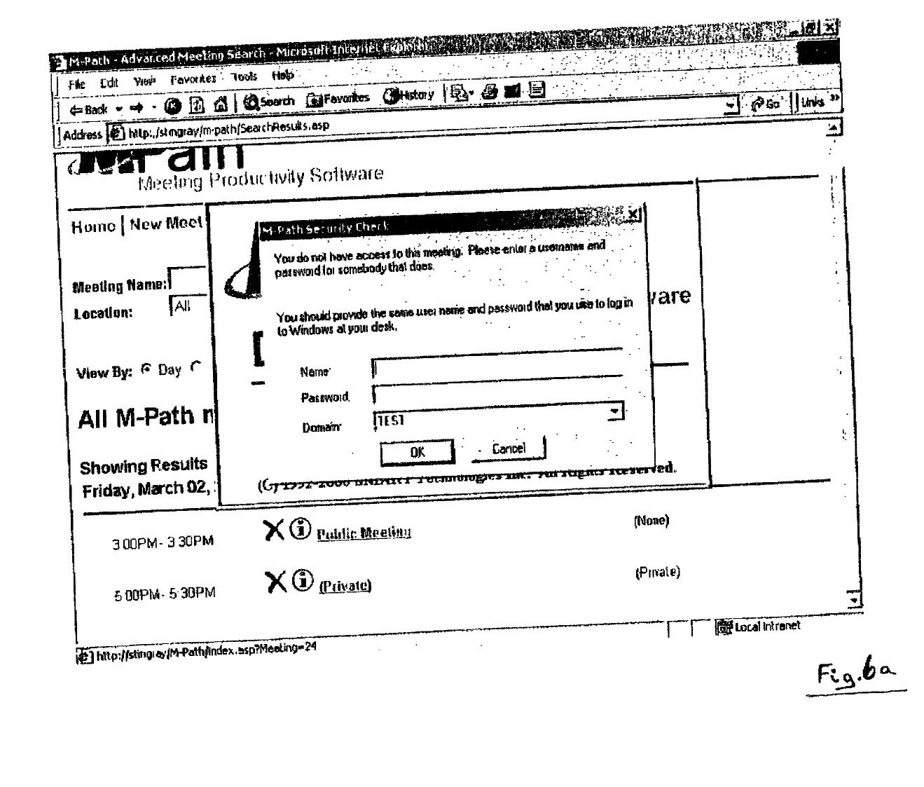

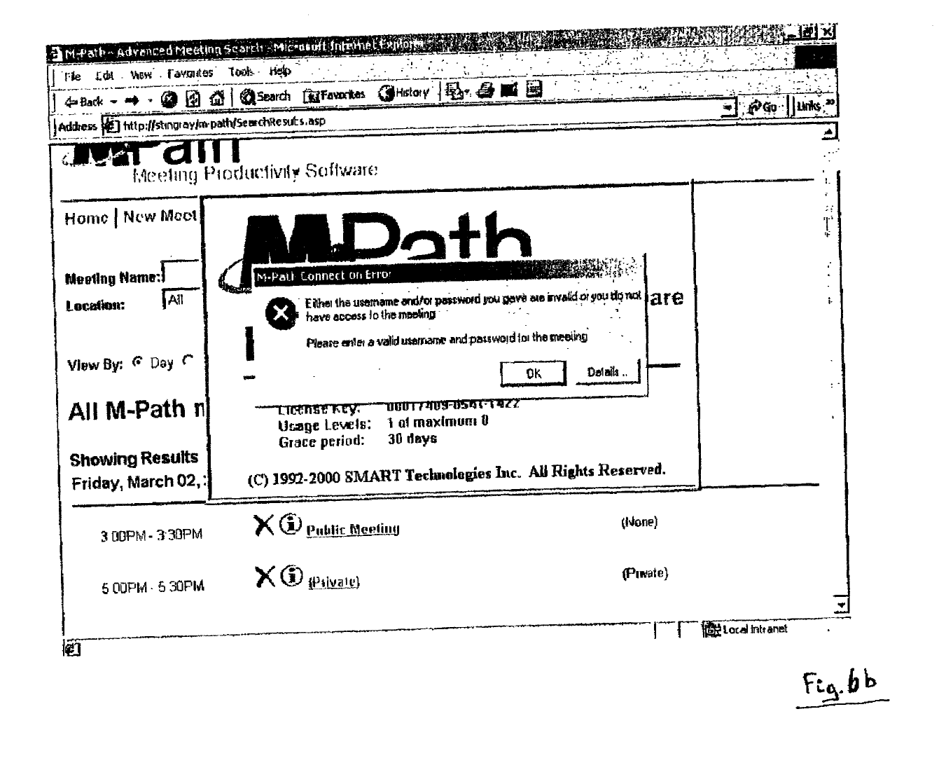

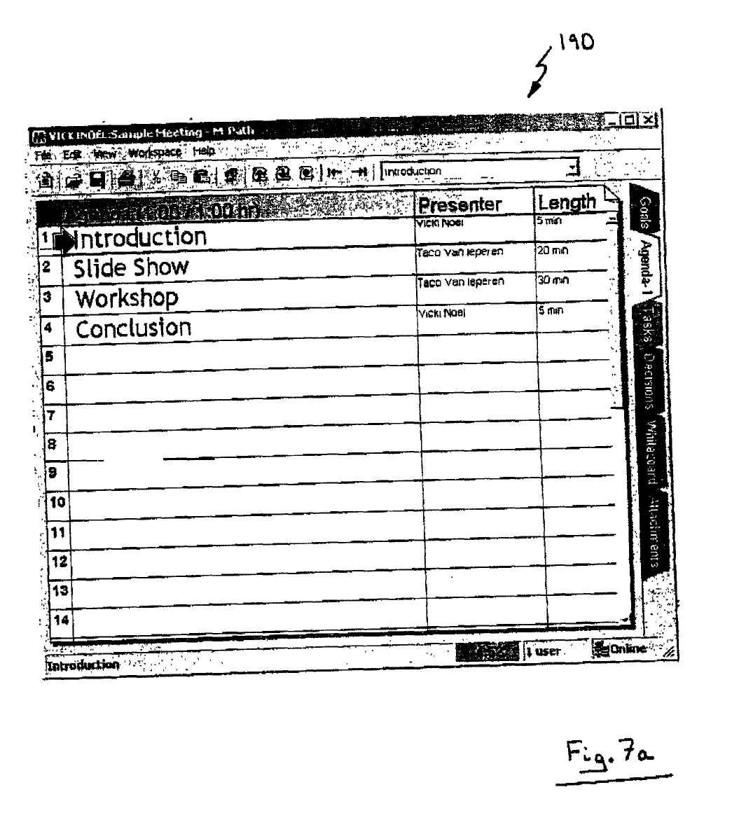

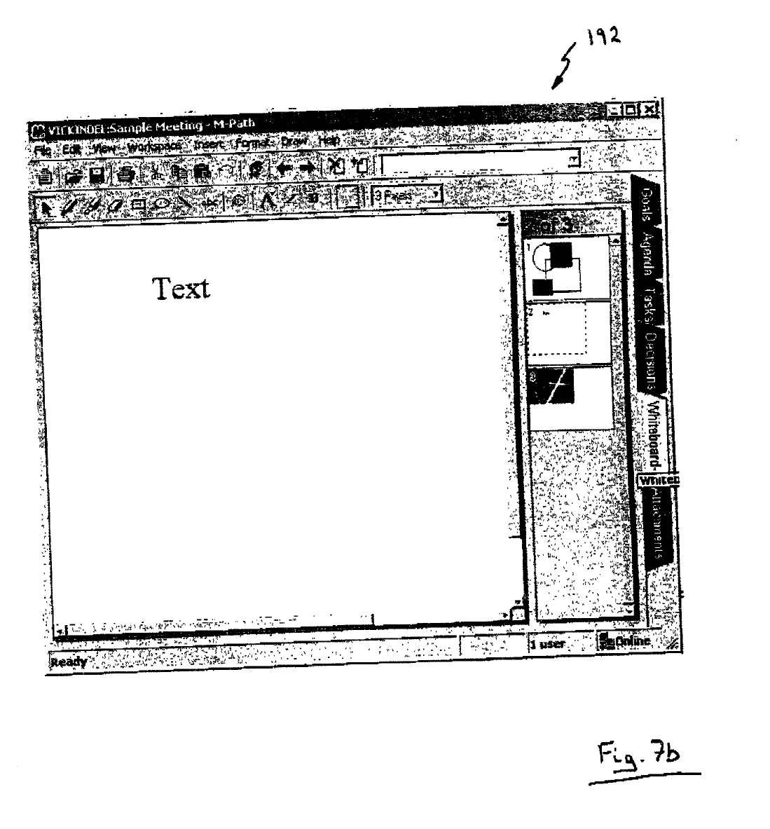

The manner in which a shared workspace is created for a new meeting will now be described with reference to FIGS. 2a and 2b assuming a user of workstation 20 is setting up the meeting and invites the user of workstation 22 to participate in the meeting. When the user wishes to schedule a new meeting, the user opens the client email and scheduling application running on workstation 20 in the conventional manner (step 100). Once the client email and scheduling client application has been opened, the user is presented with a form having a field in which the participants to be invited to the meeting are to be entered. The form also includes fields to identify the location of the meeting, the time and date of the meeting and title of the meeting. Once the form has been completed, the user generates a meeting request by hitting the send button thereby to send the completed form to the email server 12 (step 102).

When the meeting request is sent, the meeting request is intercepted by the client shared workspace application running on the workstation 20 (step 104). The client shared workspace application in turn checks the default settings of the client shared workspace application to determine if the user has specified that a shared workspace is to be created for each new meeting (step 106). If the default settings do not specify that a shared workspace is to be created for the meeting, the client shared workspace application generates a prompt that is presented to the user asking whether a shared workspace is to be created for the meeting (steps 108 and 110).

If the user in response to the prompt specifies that a shared workspace is not to be created for the meeting, the client shared workspace application releases the meeting request (step 112) and allows the meeting request to be delivered to the email server 12. The email server 12 in turn sets up the meeting and delivers the meeting request to the workstation 22 in the conventional manner.

If the user in response to the prompt specifies that a shared workspace is to be created for the meeting or if the default settings specify that a shared workspace is to be created for the meeting, the client shared workspace application communicates with the server shared workspace application causing it to create a shared workspace 18 for the meeting on the SW server 16 (step 114). With the shared workspace 18 created, the client shared workspace application opens the created shared workspace. When the shared workspace 18 is opened, the server shared workspace application sends the data stored in the shared workspace to the client shared workspace application. The client shared workspace application in turn displays the data via a graphical user interface as will be described. The graphical user interface allows the user to view and edit the created shared workspace (step 116). During editing of the shared workspace, the user can designate the shared workspace as being either public or private. The public and private designations are used to determine the information that is presented to users who are performing searches of meetings for which shared workspaces have been created.

Once the user has finished editing the created shared workspace and the shared workspace has been closed, the client shared workspace application attaches a link or shortcut to the shared workspace, to the meeting request (step 118). The meeting request with the attached shortcut is then released by the client shared workspace application allowing the meeting request to be delivered to the email server 12 (step 120). The email server 12 in turn sets up the meeting and delivers the meeting request to workstation 22 in the conventional manner. The meeting request can then be opened by the user via the client email and scheduling application to display the scheduled meeting form 130 and the attached shortcut 132 as shown in FIG. 3.

At step 114 during creation of the shared workspace, the SW server 16 asks the client shared workspace application for information concerning the new meeting (see step 140 in FIG. 4). This meeting information includes the name of the meeting, the user who scheduled the meeting (“creator”), the other participants invited to attend the meeting, the meeting location and the meeting time. Upon receipt of the meeting information, the SW server 16 then checks its local memory to determine whether any of the login identifications (IDs) of the creator and other participants associated with the new meeting are cached (step 142). For participants (including the creator) whose login IDs are not cached, the SW server 16 searches the address book on the email server 12 to obtain the login IDs of the meeting participants (step 144).

Once the login IDs of the creator and other participants are determined either from the cache or from the address book, the SW server 16 creates the secure shared workspace for the new meeting (step 146). The shared workspace 18 created by the server 16 is identified by the meeting title, the meeting time and date, the creator, the participants, the login IDs of the creator and participants and the meeting location.

When the user of workstation 22 opens the meeting request using the client email and scheduling application to display the scheduled meeting form 130 and the attached shortcut 132, the user can access the shared workspace created for the meeting by selecting the attached shortcut 132. Upon selection of the shortcut 132, the SW server 16 firstly verifies whether the user has access to the meeting (i.e. whether the user is either the creator or a participant) (see steps 150 and 152 in FIG. 5a). If the user is not the creator or a participant, access to the shared workspace is denied (step 154). If the user is the creator, the user is given full access to the shared workspace (steps 156 and 158). If the user is a participant, the user is given participant access to the shared workspace (step 160).

During verification at steps 150, 152 and 156, the SW server 16 makes a series of standard Windows API calls to “get the calling users credentials from DCOM” thereby to determine the login ID of the user requesting access to the shared workspace (see step 170 in FIG. 5b). The server SW 16 then opens the shared workspace and compares the received login ID with the login IDs associated with the participants of the meeting (step 172).

If the user is not a participant, an “Anonymous Access Permission (AAP) flag is set thereby denying the user access to the shared workspace (steps 174 and 176). If the user is a participant, the user is checked to determine whether the user is the creator. If so a “Creator Access Permission (CAP)” flag is set (step 178). If not a “Participant Access Permission (PAP)” flag is set (step 180). The set flag is used by the SW server 16 to determine the shared workspace access level assigned to the user.

The results of the verification process are presented to the user. If the user has been granted access to the shared workspace 18, the client shared workspace application running on the workstation 22 opens the shared workspace allowing the user to view and edit the shared workspace 18.

If the user has been denied access to the shared workspace, the user is presented with a form that prompts the user to login into the shared workspace by submitting their network user name, password and domain (see FIG. 6a). When the user submits their user name, password and domain, the SW server 16 checks to determine if the entered user name, password and domain are valid (step 176). If not, the AAP flag is set (step 176) and the user is notified that the login failed (see FIG. 6b). If the submitted user name, password and domain are valid, the SW server 16 proceeds to step 156 to determine whether the user is the creator or a participant. If the user is the creator, the CAP flag is set (step 178) and if the user is a participant, the PAP flag is set (step 180).

When a user updates an existing scheduled meeting that has an associated shared workspace 18 and sends the updated meeting request to the email server 12, the client shared workspace application intercepts the submitted meeting request and updates the associated shared workspace. Once this has been done, the meeting request is released allowing the meeting request to be sent to the mail server 12.

The server shared workspace application stores data input by participants in categories and this data is presented to participants accessing a shared workspace through the client shared workspace applications via an intuitive graphical user interface. Turning now to FIGS. 7a and 7b, the client shared workspace application graphical user interface is shown. As can be seen, the graphical user interface includes a number of pages each having a tab. Selecting a tab exposes the page associated with the tab. The pages allow the data stored in shared workspaces 18 to be effectively organized. In the present embodiment, the pages include a goals page, an agenda page, a tasks page, a decisions page, a whiteboard page and an attachments page. FIG. 7a shows the agenda page 190 while FIG. 7b shows the whiteboard page 192.

When a user accesses a shared workspace 18, the client shared workspace application requests the server shared workspace application to send the data stored in the shared workspace 18. The received data is stored locally by the workstation and is presented to the user via the client shared workspace application graphical user interface. The client shared workspace application polls the server shared workspace application at intervals for updates to the shared workspace data and updates the locally shared workspace data. In this manner, the shared workspace data presented to the user remains current.

The client and server shared workspace applications also allow multiple users who are participants in a scheduled meeting to access and edit the data stored in the shared workspace 18 associated with the schedule meeting simultaneously. This is achieved using an optimistic editing model.

When a user edits the shared workspace data, the client shared workspace application changes the local data in response to the user input. The client shared workspace application also changes the local data in response to shared workspace data it receives from the server shared workspace application.

Each client shared workspace application notifies the server shared workspace application whenever changes are made to the local shared workspace data. The server shared workspace application in turn places each change it receives in a list that holds changes from all participants editing the shared workspace. The server shared workspace application processes the changes in the list one at a time according to when each change was received thereby to update the shared workspace data. As each client shared workspace application polls the server shared workspace application for changed shared workspace data, the server shared workspace application sends the changed shared workspace data to the client shared workspace applications. In this manner, changes to the shared workspace data can be made by multiple participants simultaneously without the changes interfering with one another.

The client shared workspace applications also enable users to save shared workspace data off-line. When the user goes back on-line, changes made to the local shared workspace data are sent to the server shared workspace application and processed in the manner described above.

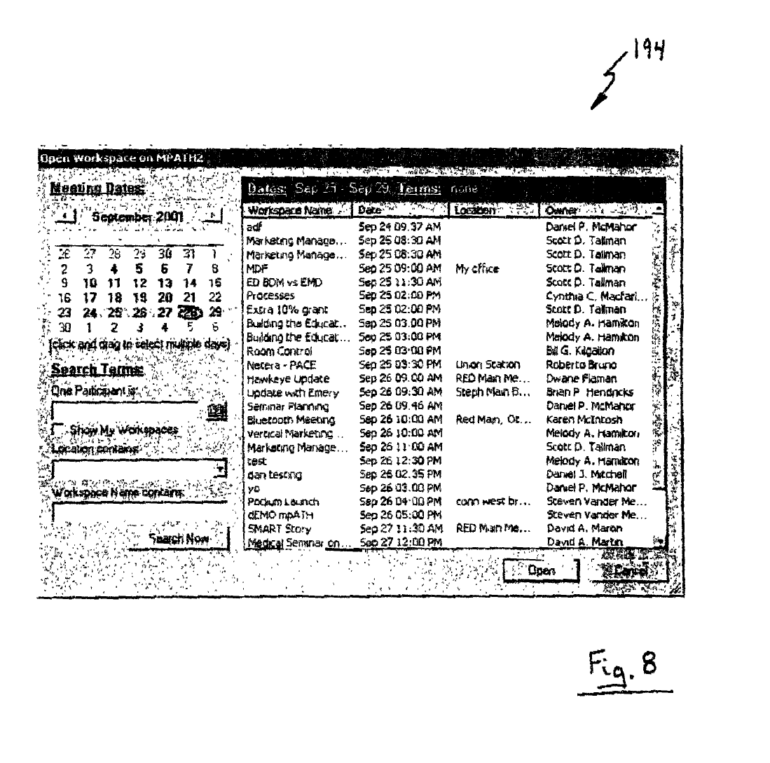

When a user opens the client shared workspace application and wishes to perform a search for meetings, a search form 194 is presented to the user as shown in FIG. 8. The form includes fields to enable the user to enter the desired search criteria. Once the search criteria has been entered into the form, the search can be initiated by hitting the “search now” button. When a search has been initiated, the SW server 16 examines the search criteria to determine the meeting workspaces that have been created which match the search criteria. The SW server 16 then examines the search criteria to determine if the search criteria are based on one or more of owner, location and time. If so a “Safe Search (SS)” flag is set and the login ID of the user is obtained by making the Windows API calls.

For each meeting that is not designated as private, the search result is returned to the user. If the meeting is private, the user's login ID is compared with the login IDs of the meeting participants. If the user's login ID is found, the search result is returned. If not, the SS flag is checked. If the SS flag is set, the title of the meeting is changed to private meeting and the participant list is emptied before the result is returned to the searcher. If the SS flag is not set, the record is deleted from the search.

Since the SS flag is used as a filter, users who are not participants of private meetings are unable to use search queries to determine sensitive information associated with private meetings.

As will be appreciated, the present invention allows secure shared workspace to be created for scheduled meetings. Data stored in the shared workspaces is accessible to participants of the scheduled meetings and is managed effectively to enable multiple participants of a scheduled meeting to view and edit shared workspace data simultaneously.

Although a preferred embodiment of the present invention has been described, those of skill in the art will appreciate that variations and modifications may be made without departing from the spirit and scope thereof as defined by the appended claims.

What is claimed is:

1. A method for creating and managing a shared workspace in a network environment comprising the steps of:
creating a shared workspace accessible to participants of a scheduled meeting;
categorizing data stored in said shared workspace; and
exposing said categorized data stored in said shared workspace to each participant of said scheduled meeting accessing said shared workspace through a graphical user interface, said graphical user interface enabling each participant to input data into appropriate categories of said shared workspace and edit categorized data exposed through said graphical user interface.

2. The method of claim 1 wherein data stored in said shared workspace is categorized into two or more of agenda, goals, decisions, tasks, file attachments, whiteboard notes and drawing categories.

3. The method of claim 1 wherein said categorized data stored in said shared workspace can be exposed to multiple participants simultaneously.

4. The method of claim 3 wherein said categorized data stored in said shared workspace can be edited by multiple participants simultaneously.

5. The method of claim 4 wherein changes to categorized data stored in said shared workspace made by participants are applied to said categorized data using an optimistic editing model.

6. The method of claim 1 wherein said shared workspace is created automatically when a new meeting is scheduled.

7. The method of claim 6 further comprising the step of sending a link to the created shared workspace to each participant of the scheduled meeting.

8. The method of claim 7 wherein the link is attached to a scheduled meeting request delivered to each participant of the meeting.

9. The method of claim 1 wherein said shared workspace is created for a new meeting in response to user input.

10. The method of claim 9 further comprising the step of sending a link to the created shared workspace to each participant of the meeting.

11. The method of claim 10 wherein the link is attached to a scheduled meeting request delivered to each participant of the meeting.

12. The method of claim 1 further comprising the step of restricting access to the categorized data stored in said shared workspace to participants of the scheduled meeting based on network login information.

13. The method of claim 12 wherein said network login information includes user login identifications.

14. The method of claim 13 wherein during creation of said shared workspace, the user login identifications of participants of said scheduled meeting are stored with said shared workspace, during access to said shared workspace by a user, the login identification of said user being compared with the login identifications stored with said shared workspace.

15. A method for creating a secure shared meeting workspace associated with a scheduled meeting in a network environment, said method comprising the steps of:
determining the participants in the scheduled meeting;
creating a workspace for the scheduled meeting; and
restricting access to the workspace to those participants in the scheduled meeting based on network login information associated with said participants.

16. The method of claim 15 wherein said network login information includes user login identifications.

17. The method of claim 16 wherein during creation of said shared workspace, the user login identifications of participants of said scheduled meeting are stored with said shared workspace, during access to said shared workspace by a user, the login identification of said user being compared with the login identifications stored with said shared workspace.

18. The method of claim 17 wherein said network login information is retrieved from an address book stored by an email and scheduling application.

19. A method of restricting access to a secure shared meeting workspace associated with a scheduled meeting entered into an email and scheduling application in a network environment to participants of the scheduled meeting, said method comprising the steps of:
during a request for access to said workspace, comparing network login information associated with the user making said request, with network login information associated with the participants in the scheduled meeting; and
permitting access to said workspace when the user network login information corresponds with the participant login information.

20. The method of claim 19 wherein the user login information is obtained by making a series of Windows API calls.

21. A system for creating and managing a secure shared workspace for a scheduled meeting comprising:
a workspace server executing a server shared workspace application for creating and managing a shared workspace associated with a scheduled meeting, data stored in said shared workspace being categorized and being accessible only to participants of said scheduled meeting;
an email server executing a server email and scheduling application; and
a plurality of workstations, each of said workstations executing a client email and scheduling application and a client shared workspace application, said client shared workspace application including a graphical user interface to enable each participant of said scheduled meeting to access and edit categorized data stored in said shared workspace.

22. A system according to claim 21 wherein data stored in said shared workspace is categorized into two or more of agenda, goals, decisions, tasks, file attachments, whiteboard notes and drawing categories.

23. A system according to claim 22 wherein the client shared workspace application communicates with the client email and scheduling application executed by each workstation, said client shared workspace application intercepting meeting requests generated by said client email and scheduling application to determine whether a shared workspace is to be created for a new meeting being scheduled or whether a shared workspace existing for a scheduled meeting is to be updated.

24. A system according to claim 23 wherein said client shared workspace application instructs the server shared workspace application to create a shared workspace for a new meeting being scheduled automatically.

25. A system according to claim 23 wherein said client shared workspace application asks the user scheduling the new meeting whether a shared workspace for the new meeting is to be created and instructs the server shared workspace application to create a shared workspace for the new meeting when specified by said user.

26. A system according to claim 23 wherein the client shared workspace application attaches a link to the shared workspace to the meeting request generated by the client email and scheduling application before the meeting request is sent to the server email and scheduling application.

27. A system according to claim 23 wherein said client and server shared workspace applications permit multiple participants to access and edit data stored in said shared workspace.

28. A system according to claim 27 wherein changes to data stored in said shared workspace are applied using an optimistic editing model.

29. A system according to claim 21 wherein said server shared workspace application restricts access to said shared workspace based on user network login information.
